(19) United States
(12) Patent Application Publication
(10) Pub. No.: US 2006/0212324 A1
(43) Pub. Date: Sep. 21, 2006

(54) Graphical representation of organization actions

(75) Inventors: Lior Okman, Palo Alto, CA (US); Noam Rotem, Palo Alto, CA (US); Barak Ori, Palo Alto, CA (US); Eyal Rubin, Palo Alto, CA (US)

Correspondence Address: CARR & FERRELL LLP, 2200 GENG ROAD, PALO ALTO, CA, 94303, US

(73) Assignee: Transparency Software, Inc.

(21) Appl. No.: 11/359,331

(22) Filed: Feb. 21, 2006

Related U.S. Application Data
(60) Provisional application No. 60/655,347, filed on Feb. 22, 2005.
(60) Provisional application No. 60/655,611, filed on Feb. 22, 2005.
(60) Provisional application No. 60/707,838, filed on Aug. 11, 2005.

(51) Int. Cl. G06F 9/44

(52) U.S. Cl. 705/7

(57) ABSTRACT

A system for graphically representing an organization action includes a communication interface and a processor. The communications interface receives communication messages between an application arid a server. The processor processes the communication messages to determine organization actions performed in the application. The processor also determines at least one metric of the organization actions based on the communication messages. The processor generates a graphical representation of the metric of the organization actions.

### CROSS-REFERENCE TO RELATED APPLICATION

This application claims the benefit of U.S. Provisional Application No. 60/655,347, filed Feb. 22, 2005 and entitled “System for Enhanced Database Analysis,” U.S. Provisional Application No. 60/655,611, filed Feb. 22, 2005 and entitled “Method for Enhanced Database Analysis,” and U.S. Provisional Application No. 60/707,838, filed Aug. 11, 2005 and entitled “Database Analysis,” the subject matter of which are all hereby incorporated by reference.

This application is related to U.S. Application entitled “System and Method for Determining Information Related to Users Interacting with an Application,” filed Nov. 23, 2005, which is hereby incorporated by reference.

### BACKGROUND

1. Technical Field

The present invention relates to graphical representations of organization actions.

2. Description of Related Art

In general, a storage server comprises a collection of data stored in a systematic way such that a user interacting with a computer application can consult the storage server to manipulate the data and define the data structure. Some examples of storage servers are web servers, directory servers, file servers, and database servers. A database server, for example, receives queries (e.g., Structure Query Language (SQL) statements) from a computer application in response to a user interacting with the computer application to create, modify, retrieve, and delete the data in the database server. An administrator user (e.g., a database administrator) typically maintains the integrity, availability, and recoverability of the data in the storage server. To aid the administrator user in performing his or her duties, various storage server analysis tools have been developed.

One limitation with the storage server tools is that the tools provide minimal information to the administrator user. The storage server tools mainly generate reports showing raw data sent from computer applications to the storage server. In one example, a database administrator for a database server has the duty of ensuring maximum performance and data integrity in an Oracle database. One example of a storage server analysis tool used by the database administrator in the performance of his or her duties is Oracle Enterprise Manager by Oracle Corporation of Redwood Shores, Calif. The Oracle Enterprise Manager allows the database administrator to manage the Oracle database by reporting database server instances, sessions, user privileges, and storage. The Oracle Enterprise Manager generates reports for the database administrator including queries sent from users and computer applications to the database server. One problem with these reports is that only the raw data such as the queries are shown, which makes the reports difficult to use because of the difficulty of correlating the raw data with the business situation.

Another limitation with the various storage server analysis tools, such as the Oracle Enterprise Manager, is that the tools provide minimal information to the administrator user about users and user interactions with computer applications accessing the storage server. A user typically does not interact directly with the storage server. The user interacts with one or more computer applications that send data to the storage server (such as the queries sent to the database server) in response to the user interactions. The storage server analysis tools (e.g., the Oracle Enterprise Manager) do not report to the database administrator actions or activities users are performing with the computer applications accessing the Oracle database beyond the queries sent to the database server.

Another limitation with the storage server tools is that the time needed to analyze and interpret the minimal information reported by the storage server tools further contributes to the financial and opportunity losses of the organizations. For example, in order to access customer information, a sales manager may attempt to log on to a sales tracking application that authenticates users of the sales tracking application against the Oracle database in the database server. If an authentication error occurs during the login, or the database is otherwise unavailable to complete the authentication process, the sales manager cannot access the customer information to process an order or contact a client. In analyzing the information provided by the storage server tools, such as the Oracle Enterprise Manager, the database administrator has difficulty finding the cause of the authentication error.

The storage server analysis tools (e.g., Oracle Enterprise Manager), for example, generate a report for the database administrator containing the queries sent from the sales application to the Oracle database server. However, if several database processes or instances are running on the database server and the Oracle database is serving several hundred users, the database administrator has to sort through information from the hundreds of users and the various computer applications used by the hundreds of users. The queries sent from the sales tracking application in response to the sales manager's login attempt can be interleaved among thousands of other queries sent by the hundreds of users. The database administrator cannot quickly identify the cause of the authentication error. Furthermore, reports provided by the storage server tools do not allow the database administrator to readily separate and identify which queries represent the sales manager's interactions with the sales tracking application.

### SUMMARY OF THE INVENTION

The invention addresses some of the above problems by graphically representing an organization action. A system for graphically representing an organization action includes a communication interface and a processor. The communications interface receives communication messages between an application and a server. The processor processes the communication messages to determine organization actions performed in the application. The processor also determines at least one metric of the organization actions based on the communication messages. The processor then generates a graphical representation of the metric of the organization actions.

The communication messages may comprise packets. The organization actions may comprise user interactions with the application. The metric may include a time, a date, a user identifier, and an application identifier. The visual representation may be a graph of the metric over time. In some embodiments, the processor receives user input for the visual representation. The processor then generates another visual representation of another metric of the organization actions. The processor may assign a color to the metric and display the color in the visual representation. The processor may also search for the organization actions based on user input.

The system for graphically representing an organization action can assist an administrator in many functions such as determining performance, ensuring security, and maintaining compliance. An administrator may ensure security by monitoring metrics of the organization actions. Also, the administrator may watch for compliance of rules by viewing the metrics of the organization actions. By graphically representing the metrics of the organization actions, an administrator can easily monitor, analyze, and diagnose the operations of the application and the server.

### BRIEF DESCRIPTION OF THE DRAWINGS

FIG. 1 is a block diagram of a system for determining interactions of users with an application in an exemplary implementation of the invention;

FIG. 2 is a flow chart for displaying organizations actions in an exemplary implementation of the invention;

FIG. 3 is a screenshot of a dashboard for business actions in an exemplary implementation of the invention;

FIG. 4 is a screenshot of a business action locator in an exemplary implementation of the invention;

FIG. 5 is a screenshot of results of locating business actions in an exemplary implementation of the invention;

FIG. 6 is a screenshot of a chart of business action instances by business action types correlated with database events in an exemplary implementation of the invention;

FIG. 7 is a screenshot of a chart of business action instances by sessions correlated with database events in an exemplary implementation of the invention;

FIG. 8 is a screenshot of a business action incident viewer in an exemplary implementation of the invention;

FIG. 9 is a screenshot of the business action general details in an exemplary implementation of the invention;

FIG. 10 is a screenshot of the business action details of SQL statements in an exemplary implementation of the invention;

FIG. 11 is a screenshot of the business action transactions viewer in an exemplary implementation of the invention;

FIG. 12 is an X-ray vision screenshot in an exemplary implementation of the invention;

FIG. 13 is a screenshot including a packet detail window in an exemplary implementation of the invention; and

FIG. 14 is a block diagram of the collector and the analyzer in an exemplary implementation of the invention.

### DETAILED DESCRIPTION OF THE INVENTION

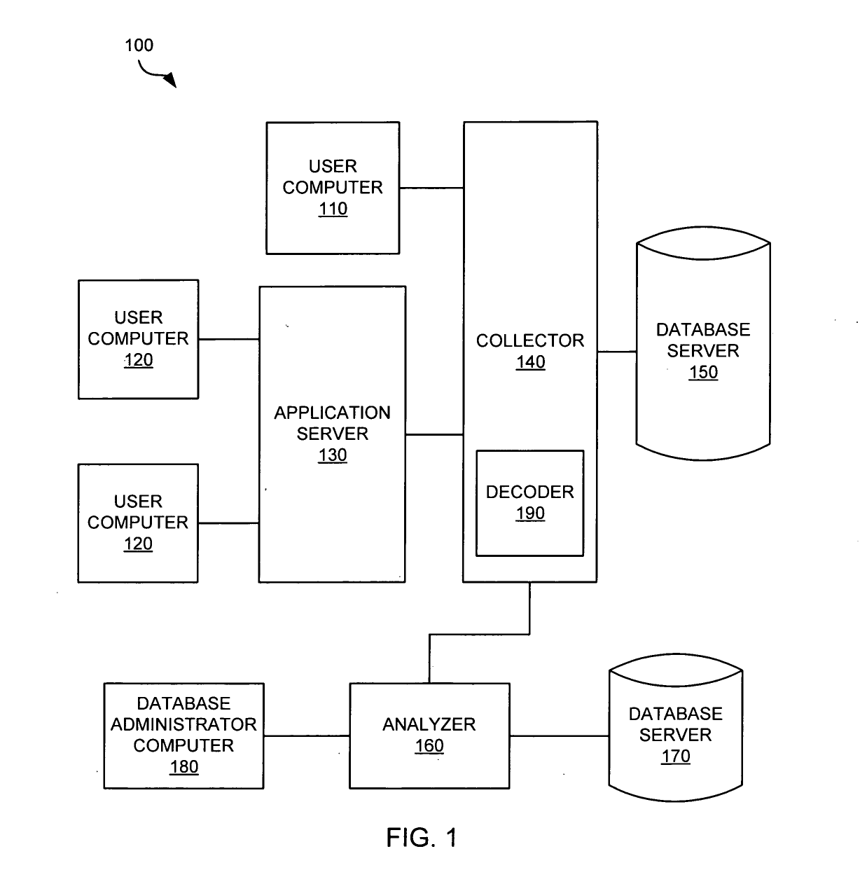

FIG. 1 is a block diagram of a system 100 for determining interactions of users with an application in an exemplary implementation of the invention. The system 100 includes a user computer 110, user computers 120, an application server 130, a collector 140, a database server 150, an analyzer 160, a database server 170, and a database administrator computer 180. The collector 140 includes a decoder 190.

The user computer 110 is linked to the collector 140. The user computers 120 are linked to the application server 130. One user computer 110 and two user computers 120 are shown for the sake of simplicity, although multiple user computers 110 and more than two user computers 120 may be included. The application server 130 is linked to the collector 140. Other embodiments may have multiple application servers 130 that are also linked to the collector 140. The collector 140 is linked to the database server 150 and the analyzer 160. The analyzer 160 is linked to the database server 170 and the database administrator computer 180.

Some examples of the user computers 110 and 120 and the database administrator computer 180 are general purpose computers. In one example, the user computer 110 comprises a personal computer (PC) that executes a software application for communicating with the database server 150 (e.g., by sending SQL queries to the database server 150 via the collector 140). In another example, the user computers 120 comprise PCs that execute applications for communicating with the database server 150 through the application server 130. In yet another example, the user computers 110 and 120 may comprise a first database server sending SQLs to a second database server (e.g., the database server 150) via a database link mechanism. Alternatively, the user computers 110 and 120 and the database administrator computer 180 may comprise any workstations, mainframes, networked clients, and/or application servers. An administrator user, such as a database administrator for the database server 150, uses the database administrator computer 180 to monitor performance of the system 100. The administrator user may be a natural person or a computer program, job, or process.

The application server 130 comprises hardware and/or software elements that execute software applications. The application server 130 may accept input from another computer (e.g., the user computers 120). In this example, the application server 130 comprises a BEA WebLogic Server running a Medical Records Application. The Medical Records Application is configured to transmit SQL queries to a database server (e.g., the database server 150) on behalf of the user computers 120. Alternatively, the application server 130 may comprise an application executed on the server (e.g., the database server 150). The database server 150 comprises hardware and/or software elements that store data and provide access to the data. The database server 150 may store a collection of data in a systematic way such that a user interacting with a computer application (e.g., the application server 130) can consult the database server 150 to manipulate the data and define the data structure. One example of the database server 150 is an Oracle 9i Database application executed on a server running the Red Hat 2.1 Advanced Server operating system.

The collector 140 comprises hardware and/or software elements that inspect data sent from an application (e.g., the application server 130) to a server (e.g., the database server 150). Some examples of the data are server protocols (e.g., Transmission Control Protocol/Internet Protocol (TCP/IP) packets, Hypertext Transfer Protocol (HTTP) messages), Lightweight Directory Access Protocol (LDAP) requests and responses, Simple Object Access Protocol (SOAP) data, Internet Inter-ORB Protocol (IIOP) data, Structured Query Language (SQL) statements, and inter-process communications. An application is any program designed for end users that performs tasks and/or functions for the end-user, whether a natural person or another computer program, process, job, or service. Applications typically interact, call, or sit on top of system software and operating systems. Some examples of applications are word processors, web browsers, and database clients.

A server is any hardware and/or software elements that provide services through a communication network and may provide access to network resources. For example, a file server is a computer and storage device dedicated to storing files where a user on the network can store files on the file server. A server can also refer to the computer software program that is managing resources rather than the entire computer. Some examples of the server are database servers (e.g., Oracle, UDB/DB2, MySQL, IMS, Sybase, Microsoft SQL Server, as well as any other flat-file database, hierarchical database, and relational database), directory servers (e.g., Lightweight Directory Access Protocol (LDAP) servers), file servers, storage servers, message servers, and other application servers.

The collector 140 of this exemplary embodiment, for example, comprises a hardware database proxy server. The collector 140 receives data (e.g., queries) on behalf of the database server 150 and forwards the queries to the database server 150. Alternatively, the collector 140 may comprise a software proxy. For example, in one embodiment, the collector 140 comprises a software proxy running on the database server 150. In some embodiments, the collector 140 comprises a “sniffer” that sniffs the data from a communication network coupling the application server 130 and the database server 150. The collector 140 may be configured to sniff any client/server configuration. Alternatively, the collector 140 may-inspect the data by inspecting memory activity of the server, inspecting inter-process communications, inspecting server processes, inspecting server logs, inspecting driver instrumentation activity for the server, inspecting protocol packets accessing the server, and inspecting other network levels.

Advantageously, the collector 140 may be embodied in hardware, software, and/or firmware to provide flexibility for integrating the collector 140 into existing hardware and software deployments. Additionally, the sniffing feature of the collector 140 provides transparency to the user computer 110 and the application server 130 during access to the database server 150. In some embodiments, the collector 140 includes the decoder 190. The decoder 190 comprises hardware and/or software elements that decode the data inspected by the collector 140. For example, the decoder 190 may decode the data comprising Oracle 9i Database Transparent Network Substrate (TNS) and Two-Task Common (TTC) data streams. The decoder 190 then may transmit the decoded data to the analyzer 160. In still other embodiments, the decoder 190 may be located outside of the collector 140. The decoder 190 may also be included in the analyzer 160.

The analyzer 160 comprises hardware and/or software elements that determine an “interaction” of a “user” with an application and a server. The analyzer 160 determines the interaction directly or indirectly based on data sent from the application to the server in response to the interaction of the user with the application.

A “user” may be a natural person and/or another computer application interacting with the application. For example, the user may be any service, job, process, and/or thread interacting with the application. In another example, the user may be a first database server sending SQLs to the application (e.g., a second database server) via a database link mechanism. An “interaction” of a user with an application comprises any activity, contact, interface, or task by the user with the application that directs the application to send data to the server. Some examples of interactions of users with applications are clicking a button, generating a report, logging on to the applications, and entering data into the applications.

In some embodiments, the analyzer 160 determines a “technical transaction”. A “technical transaction” is a sequence of one or more server protocol statements (e.g., SQL queries) and an end sequence indicator. An end sequence indicator comprises, for example, a “COMMIT” or “ROLLBACK” statement, cursor activity, a predefined delimiter, or a continuous number of seconds of idle connection time at the server. A technical transaction may include a sequence of commands that insert, delete, update, or retrieve data from an enterprise storage system (e.g., the database server 150). In another example, a technical transaction is an atomic operation where either a server approves the one or more server protocol statements and therefore performs the one or more protocol statements (Commit) or the server rejects the one or more server protocol statements (i.e. none of one or more server protocol statements are performed (Roll back)).

In some embodiments, the analyzer 160 determines a “business action” performed by the user. A “business action” is any step, function, or procedure for a business that an application performs in response to a user interaction with the application. Some examples of business actions are “user clicks,” “services,” and “jobs”. A “user click” is any action (e.g., a mouse click or key press) of a user with a user interface device (e.g., a mouse or keyboard) on an interactive element (e.g., a button) in an application that causes the application to access a server. A user click business action may begin after the user click on the first interaction with the server and end on the last interaction with the server. A “service” is any request by a first application to a second application to provide a function (e.g., fraud detection or weather check). A service business action may begin after the service request and on the first interaction with the server and end on the last interaction with the server. A “job” is any function, routine, or procedure that is activated in a recurring fashion (e.g., by a job scheduler). A job business action may comprise interaction performed by the job from the job start to finish.

Some examples of business actions are a user click on a “Submit” button that approves a purchase made on an e-commerce site, a user click on a “Submit” button choosing a hotel to be reserved in a vacation reservation application, a service requested by another application to check fraud detection, and a report job executed on an hourly basis that issues a summary of new customers added to a system in the last hour. The analyzer 160 may determine business actions based on cursor activity, connection activity to a server (e.g., the database server 150), schema activities, and time indicators for the user, application, and/or the server, and one or more technical transactions.

In some embodiments, the analyzer 160 determines a “business scenario” between the user, the application, and the server. A business scenario comprises a sequence of user-application interactions. One example of a business scenario includes one or more business actions and a time indicator. The time indicator comprises, for example, the execution and/or idle time of the one or more business actions, the time the user takes between user interactions with the application, and/or the time that the server is idle (e.g., idle time for the database server 150). Another example of a business scenario is a “Vacation Reservation” which includes a sequence of business actions (e.g., “Reserve Flight -> Confirm Flight Reservation -> Reserve Hotel -> Confirm Hotel Reservation -> Reserve Car -> Confirm Car Reservation -> Proceed to checkout -> Payment Mechanism -> Approve Purchase Order”).

In one example of operation, the user computer 110 and the application server 130 send data to the database server 150 via the collector 140 to enable interactions of users (e.g., technical transactions, business actions, and/or business scenarios) with the user computers 110 and 120, the application server 130, and the database server 150. The collector 140 acts as a proxy to the database 150 and inspects the data sent to the database server 150.

The decoder 190 in the collector 140 converts the data (e.g., SQL queries) to a format understandable by the analyzer 160. The collector 140 then forwards the SQL queries to the analyzer 160. The analyzer 160 determines the interactions of the users with the application (e.g., the application server 130) based on the SQL queries. The analyzer 160 stores the interactions, including the SQL queries, in the database server 170.

Advantageously, the collector 140, the analyzer 160, the database server 170, and the database administrator computer 180 may provide an administrator user a report or log of the interactions of users on the database administrator computer 180. The administrator user can then determine business level violation of policies. The administrator user can also quickly identify interactions of users that result in poor performance, unavailable resources, or errors in the database server 150.

Advantageously, the collector 140, the analyzer 160, the database server 170, and the database administrator computer 180 may generate a report containing the technical transactions and business actions of interactions of users with the application server 130 and the database server 150. The database administrator may adjust performance of the application server 130 and/or the database server 150 to prioritize one or more technical transactions and/or business actions. The database administrator can determine from the report that some user interactions with the application server 130 (i.e., execution of particular technical transactions and/or business actions) will deteriorate server performance and/or otherwise affect interactions of other users with the application server 130 and the database server 150. Additionally, if types of technical transactions and/or business actions should only be executed by particular users, the database administrator may quickly determine from the report whether executions or abuses have occurred by non-authorized users.

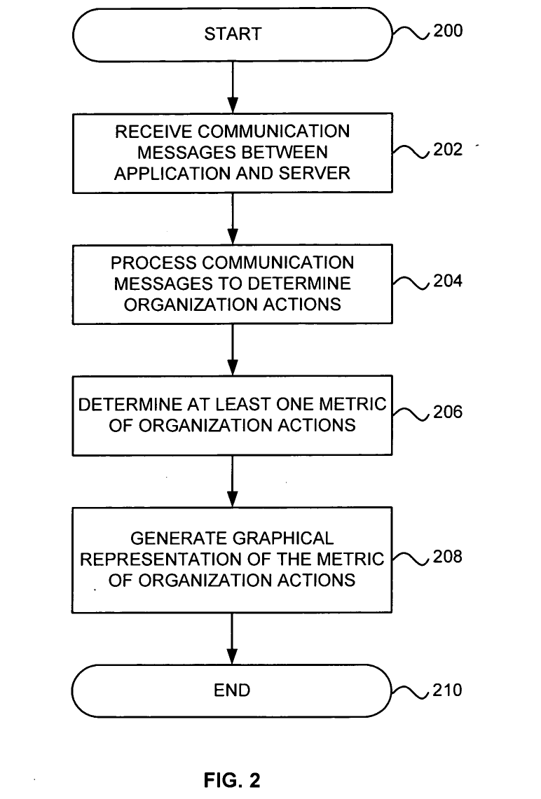

Graphical Representation of Organization Actions—FIGS. 2-13

A system for graphically representing an organization action includes a communication interface and a processor. The communication interface receives communication messages between an application and a server. The processor processes the communication messages to determine organization actions performed in the application. The processor also determines at least one metric of the organization actions based on the communication messages. The processor then generates a graphical representation of the metric of the organization actions.

An organization action is any step, function, or procedure for an organization that an application performs in response to a user interaction with the application. One example of an organization action is a business action. Other embodiments may show graphical representations for a plurality of organization actions such as a group of business actions or a business scenario.

The system for graphically representing an organization action can assist an administrator in many functions such as determining performance, ensuring security, and maintaining compliance. An administrator may ensure security by monitoring metrics of the organization actions. Also, the administrator may watch for compliance of rules by viewing the metrics of the organization actions.

By graphically representing the metrics of the organization actions, an administrator can easily monitor, analyze, and diagnose the operations of the application and the server. Graphically representing only the communication messages between the application and server can be difficult because too many unnecessary or irrelevant communication messages distract or confuse the administrator from proper analysis and diagnosis. Abstracting the communication messages into organization actions and generating a visual representation of the metrics of the organization actions helps the administrator easily understand the operations of the application and the server. In one example, the system generates a graph of metrics over time to provide an overview of the execution of the organization action. A graph of metrics over time may assist the administrator in identifying errors or pinpointing problematic areas in the execution of the organization action.

Some embodiments allow a drill down of the metrics of the organization action into the communication message level such as the packet level. With the graphical display of the metrics of the organization action and the ability to drill down, administrators can focus their analysis and diagnosis on specific errors or problem areas.

FIG. 2 depicts a flow chart for displaying organizations actions in an exemplary implementation of the invention. FIG. 2 begins in step 200. In step 202, the collector 140 receives communication messages between an application in the application server 130 and the database server 150. The communication messages are the data that is sent between the application and the server. In one example, the communication messages are packets which include SQL statements. Other examples of communication messages are TCP/IP packets containing TTC packets (see FIG. 1). In other embodiments, the communication messages are received from memory snapshots, which include the communication messages. In this example, the collector 140 is the communication interface that receives communication messages between an application and the server. In other embodiments, the communication interface that receives communication messages is located within the analyzer 160.

In step 204, the analyzer 160 processes the communication messages to determine organization actions performed within the application in the application server 130. In this example, the organization action is a business action. In step 206, the analyzer 160 determines at least one metric of the organization actions based on the communication messages. A metric is any measurement, statistic, calculation and/or information related to an organization action executed in an application and server. Some examples of metrics are execution time, types of packets, and packet counts.

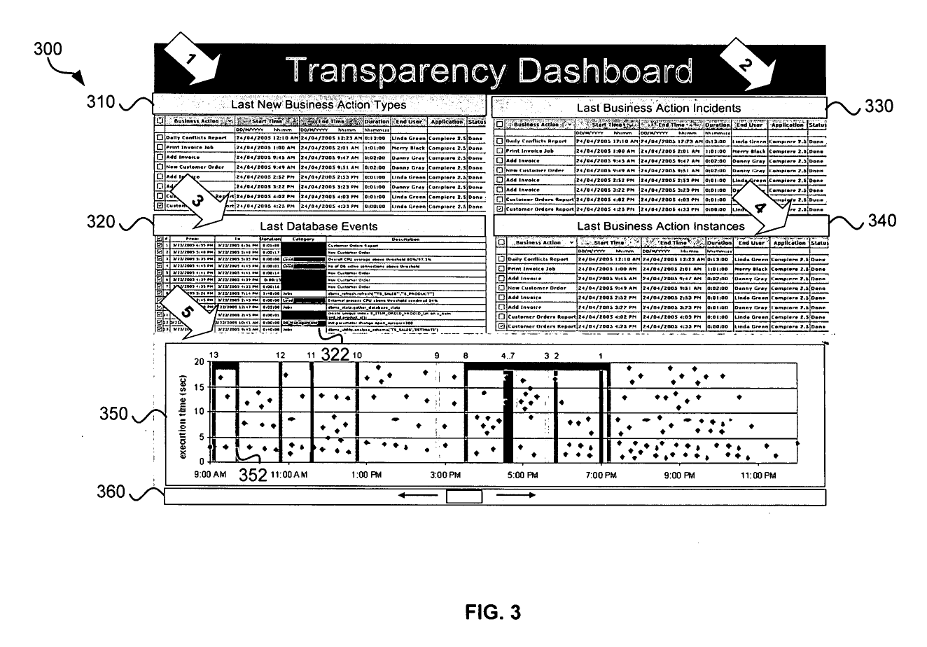

In step 208, the analyzer 160 generates a graphical representation of the metric of the organization action. The generation of a graphical representation in step 208 may occur immediately after step 206. Alternatively, the generation of a graphical representation in step 208 may occur way after the determination of the metrics of the organization action. In one embodiment, the analyzer 160 may store the metrics and retrieve the metrics before generating the graphical representation of the metrics of the organization actions. The analyzer 160 may display any metric of the organization action on the database administrator computer 180 or any computer or device connected to the analyzer 160 through a network. The graphical representation is any screen, display, report, or any other visual representation of the metric of the organization action. Some examples of screenshots are shown in FIGS. 3-13. FIG. 2 ends in step 210.

FIG. 3 depicts a screenshot 300 of a dashboard for business actions in an exemplary implementation of the invention. This screenshot 300 of the dashboard provides an “all-in-one” view of the last new business action types 310, the last database events 320, the last business action incidents 330, the last business action instances 340, and a chart 350. A business action type is a category or class of business actions. Database events are events that might impact or influence the database performance. A business action incident is a business action that is not executing as expected. A business action instance is an occurrence, execution, or usage of a business action.

The last new business action types 310 include the columns of business action, start time, end time, duration, end user, application, and status. The last database events 320 include the database event number, the from and to fields for date and time, direction, category, and description of the last database events. The last business action incidents 330 include the business action, start time, end time, duration, end user, application, and status. The last business action instances 340 include the business action, start time, end time, duration, end user, application, and status. The last business action instances 340 are a list of last business actions that have executed.

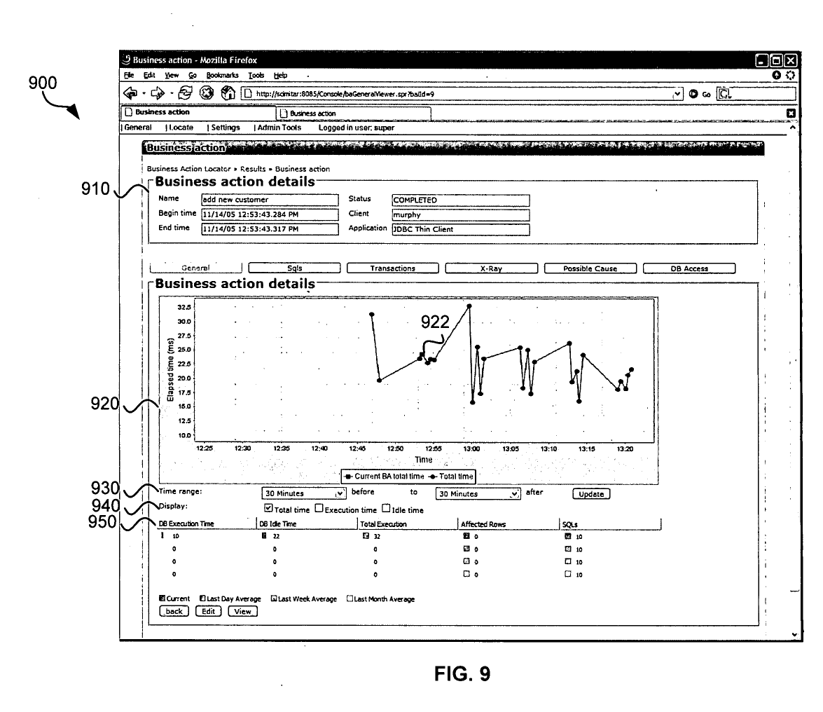

The chart 350 displays a graph of the total response time over time. The dots on the graph correspond to the business actions and incidents. Also, the vertical bars 352 are colored to correspond to the categories 322 of the last database events. The slider 360 controls the range of time that is displayed in the above described elements. In some embodiments, the screenshot 300 refreshes periodically such as every few seconds or minutes to reflect up-to-date information. When the user selects a business action on the screenshot 300, the analyzer 160 displays the details of the business action as depicted in FIGS. 9-13, which are described below.

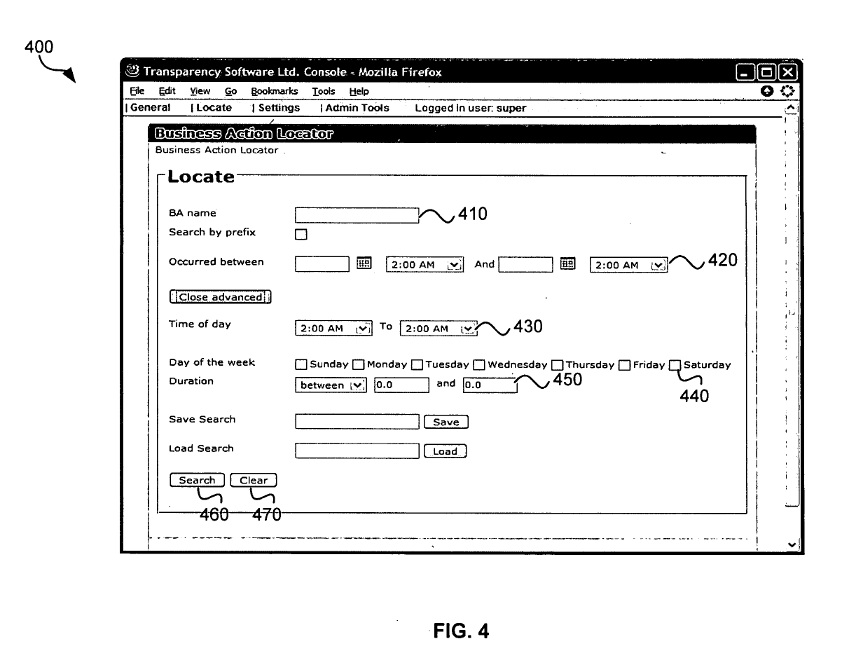

FIG. 4 depicts a screenshot 400 of a business action locator in an exemplary implementation of the invention. The business action locator screenshot 400 includes different types and/or combinations of search criteria to search for a business action. The business action (BA) name field 410 allows searching or locating business actions based on a partial or full business action name. A user may also search the business actions based on the from and to dates and times fields 420, the time of day fields 430, the day of the week fields 440, and the duration 450.

Once the search criteria are entered in, the user can press the search button 460 to perform the search. The user may also clear the search criteria by pressing the clear button 470. Other search criteria not shown in FIG. 4 may be business action type automatic generated name, incidents at the alarm, warning, or all levels, database schema, business action property (e.g. application), database object accessed, TCP relevant parameters (i.e. client IP and client port), and instance values such as bind values or literals in SQL.

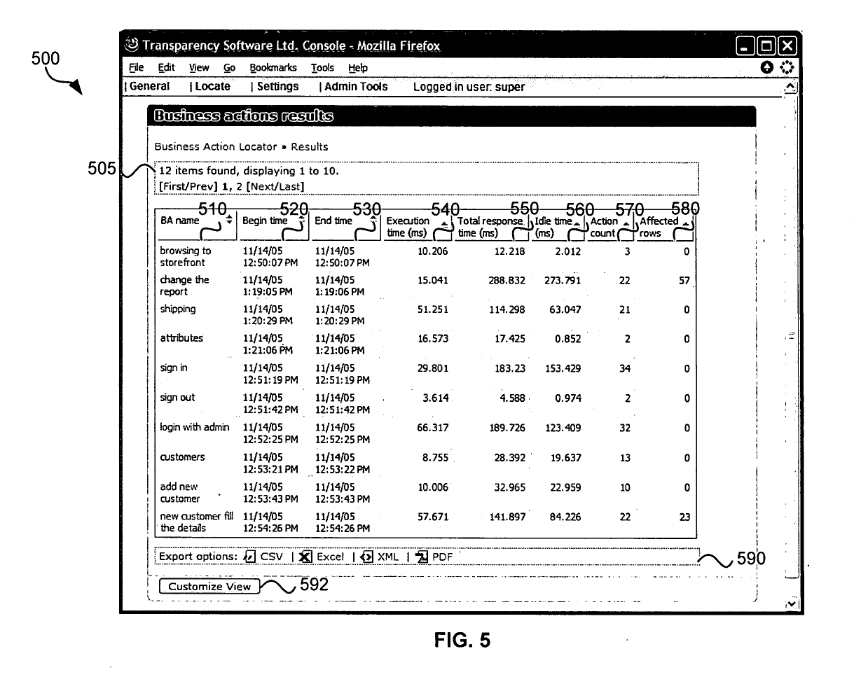

FIG. 5 depicts a screenshot 500 of results of locating business actions in an exemplary implementation. of the invention. After the analyzer 160 performs the search of the business actions, the analyzer 160 displays the screenshot 500 of the results of locating a business action. The analyzer 160 displays in the pager 505 how many business actions were found and provides controls for moving to different pages of the search results. The results of the business action search include the business action name 510, the begin time 520, the end time 530, the execution time 540, the total response time 550, the idle time 560, the action count 570, and the affected rows 580. The export options 590 allow the exportation of the search results of the business action to a CSV, Excel, XML, or PDF file. The customize view button 592 allows the users to choose which information of the business action to display and in which order. When the user selects a business action on the screenshot 500, the analyzer 160 displays the details of the business action as depicted in FIGS. 9-13, which are described below. The analyzer 160 may also perform a similar search for business action types in other embodiments.

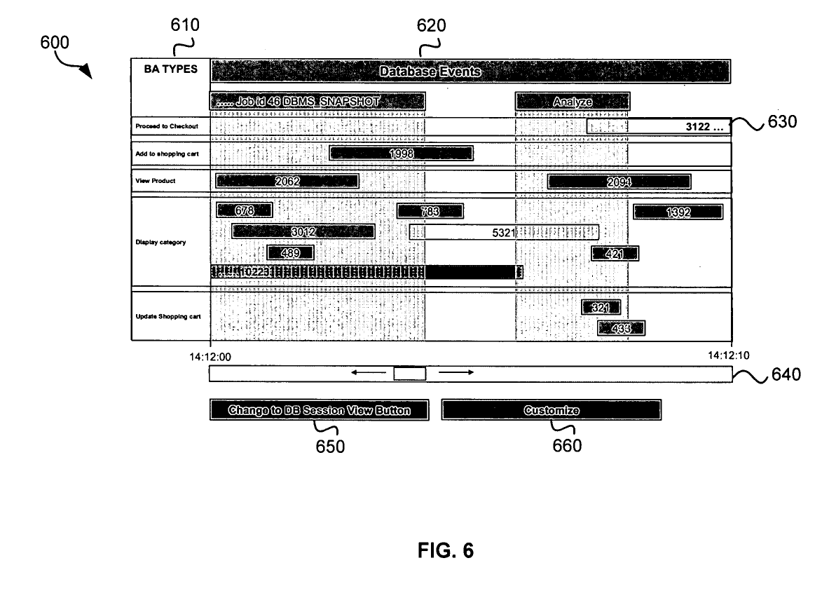

FIG. 6 depicts a screenshot 600 of a chart of business action instances by business action types correlated with database events in an exemplary implementation of the invention. The chart is similar to a Gantt chart with the execution of business action types. The analyzer 160 displays the chart in rows organized by business action types 610. Some examples of business action types are “proceed to checkout”, “add to shopping cart”, “view product”, “display category”, and “update shopping cart”. The execution of the business actions may be colored in green, yellow (warning incident), and red (alarm incident) to graphically indicate the incident status of execution of the business action.

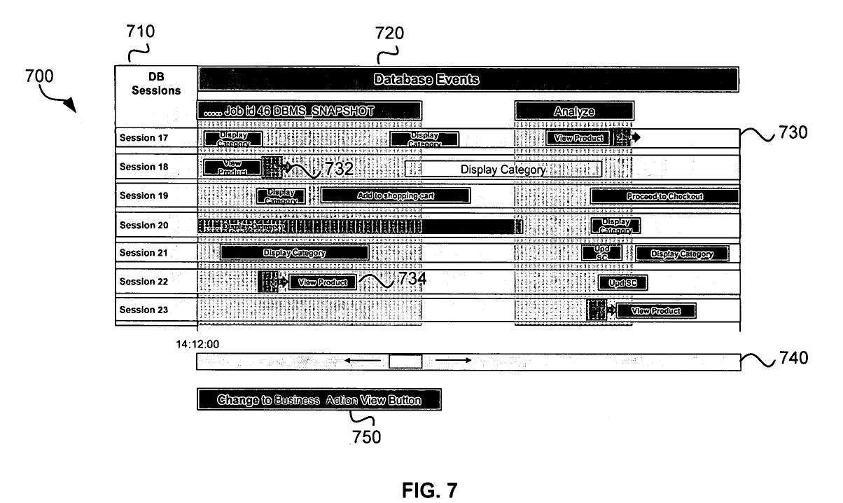

The analyzer 160 displays the database events 620 such as the business actions for the business action type along a timeline based on when the business action was executed. In one example, business action ID number “3122” 630 is a “proceed to checkout” business action type. The user may scroll through the timeline through the slider 640. In screenshot 600, the analyzer 160 displays the timeline from 14:12:00 to 14:12:10. If the Change to DB Session View Button 650 is pressed, the analyzer 160 displays the screen in FIG. 7 discussed below. The customize button 660 allows the user to customize what information from the business action is displayed on the timeline. The customize button 660 may also allow filtering based on business action types, incidents, duration, and database events groups to display. When the user selects a business action on the screenshot 600, the analyzer 160 displays the details of the business action as depicted in FIGS. 9-13, which are described below.

FIG. 7 depicts a screenshot 700 of a chart of business action instances by sessions correlated with database events in an exemplary implementation of the invention. The analyzer 160 displays the chart in rows organized by DB Sessions 710. The analyzer 160 displays the database events 720 such as the business actions for the DB session 710 along a timeline based on when the business action was executed. In one example, session seventeen 730 includes the business action types of display category and view product. In another example, business action 732 (view product) for session eighteen spans over another connection to business action 734 (view product) for session twenty two. The user may scroll through the timeline using the slider 740. If the change to Business Action View Button 750 is pressed, the analyzer 160 displays the screen in FIG. 6 discussed above. When the user selects a business action on the screenshot 700, the analyzer 160 displays the details of the business action as depicted in FIGS. 9-13, which are described below.

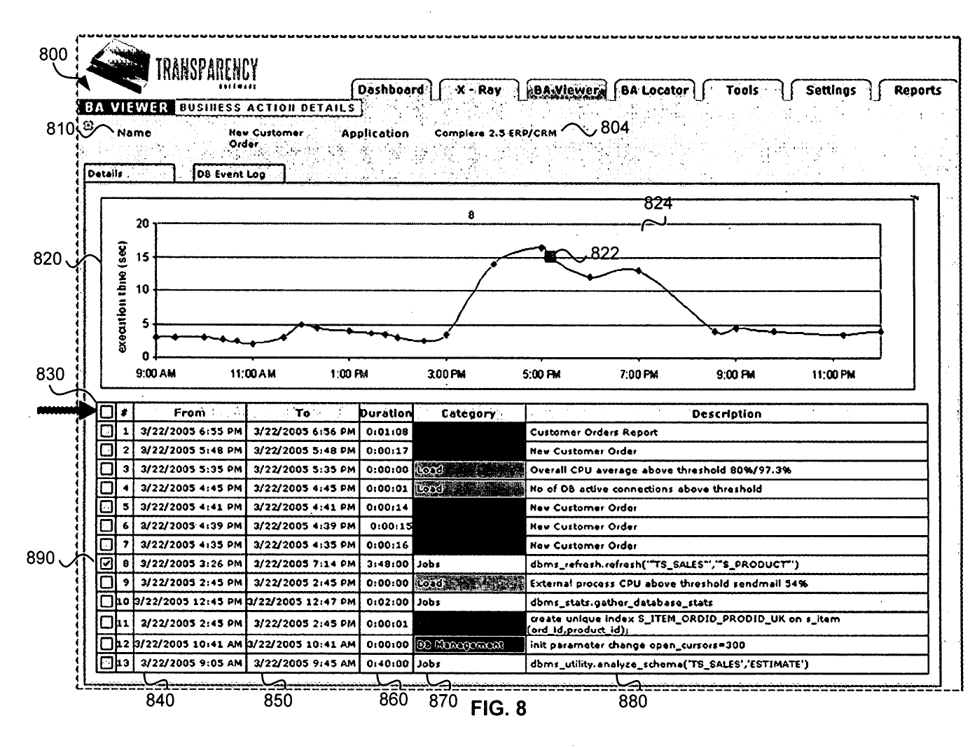

FIG. 8.depicts a screenshot 800 of possible causes for business action incidents in an exemplary implementation of the invention. The screenshot 800 shows the name 810 of a particular business action. In this example, the screenshot 800 displays details for the “New Customer Order” business action. The screenshot 800 includes a chart 820 depicting a graph of execution time over time of one or more instances of the “New Customer Order” business action. The dots on the graph correspond to the one or more instances of the “New Customer Order” business action. A square 822 depicts an instance of the “New Customer. Order” business action related to the name 810 around which analyzer 160 determines possible causes. The square 822 depicts an instance that is being viewed and/or investigated. Horizontal and vertical bars 824 represent the start/end time and duration of a possible cause.

The screenshot 800 further includes a table 830 depicting start time 840 (“From”), end time 850 (“To”), duration 860, category 870, and description 880 for one or more possible causes related to the instances of the “New Customer Order” business action. The analyzer 160 displays a color for the category 870 for each business action. For example, the analyzer 160 may color red the category 870 field to signify a business action incident. The analyzer 160 may use other colors, such as yellow for database “jobs” (e.g., database event 890) and green for database management events. Also, the bars 824 are colored to correspond to the colors of the categories 850.

The screenshot 800 allows the administrator to quickly see possible causes related to business action incidents. The administrator can select the checkbox next to a possible cause to have the analyzer 160 display the bars 824 for the possible cause on the chart 820. In this example, the administrator can see from the chart 820 that the database event 890 possibly caused an increase in the execution time of the particular business action instance that is being viewed (e.g., depicted by the square 822) of the “New Customer Order.” The rise and fall in execution time of business action instances in the chart 820 correspond closely to the duration of the execution time of the database even 890 as depicted by the bars 824.

FIG. 9 depicts a screenshot 900 of the business action general details in an exemplary implementation of the invention. The business action details 910 include the name of the business action, the status, begin time, end time, client, and application. A graph 920 shows elapsed time over time for business action instances. The square 922 on the graph 920 represents the total time for the current business action instance, while the dots represent the total time for the remaining business action instances for the business action. The time range 930 controls the range of the timeline that is displayed in the graph 920. The display boxes 940 control whether the total time, execution time, and/or idle time is shown in the graph 920. The chart 950 shows the DB execution time, DB idle time, total execution time, affected rows and number of SQLs for the current, last day average, last week average, and last month average.

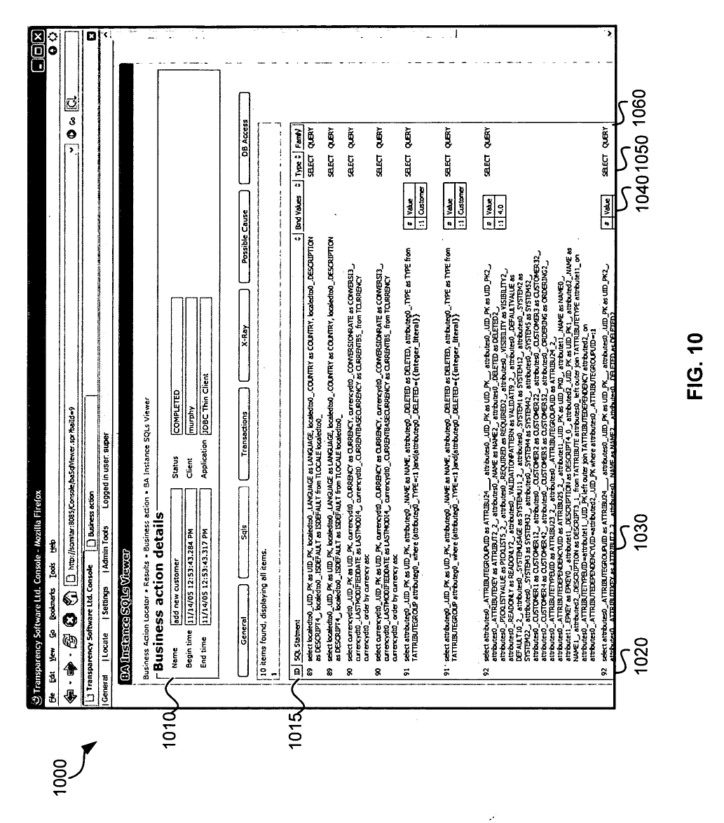

FIG. 10 depicts a screenshot 1000 of the business action details of SQL statements in an exemplary implementation of the invention. The business action details 1010 include the name of the business action, the status, begin time, end time, client, and application. The screenshot 1000 also includes a table 1015 for the SQL statements of the specified business action. The table 1015 includes SQL statement ID 1020, the SQL statement 1030, the bind values 1040, the SQL type 1050, and the SQL family 1060.

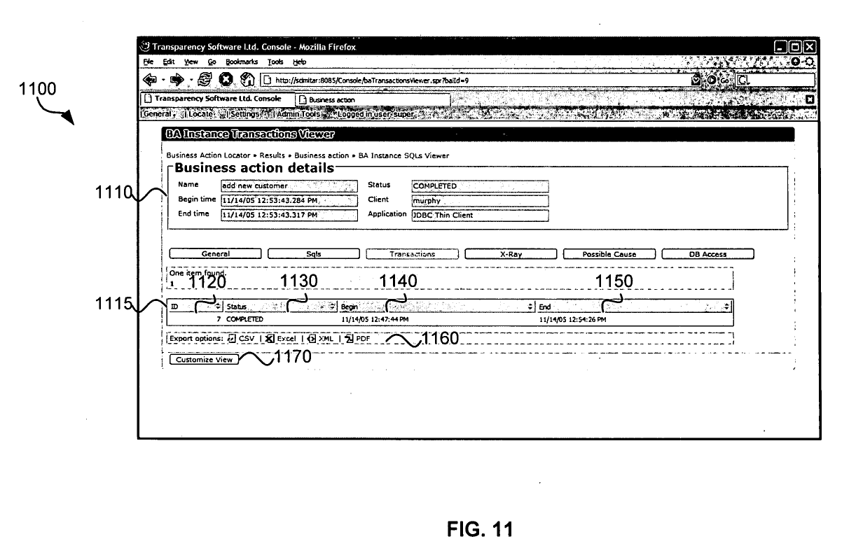

FIG. 11 depicts a screenshot 1100 of the business action transactions viewer in an exemplary implementation of the invention. The business action details 1110 include the name of the business action, the status, begin time, end time, client, and application. The screenshot 1100 also includes a table 1115 for the transactions of the business action. The table 1115 includes the columns of transaction ID 1120, the status 1130, the begin time 1140, and the end time 1150. The export options 1160 allow the exportation of the transactions of the business action to a CSV, Excel, XML, or PDF file. The customize view button 1170 allows the users to choose which information of transactions of the business action will be displayed and in which order.

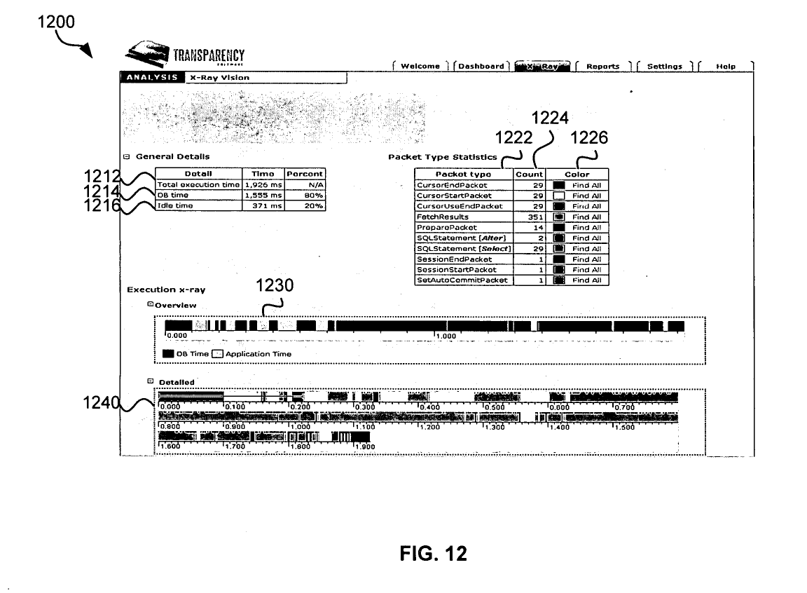

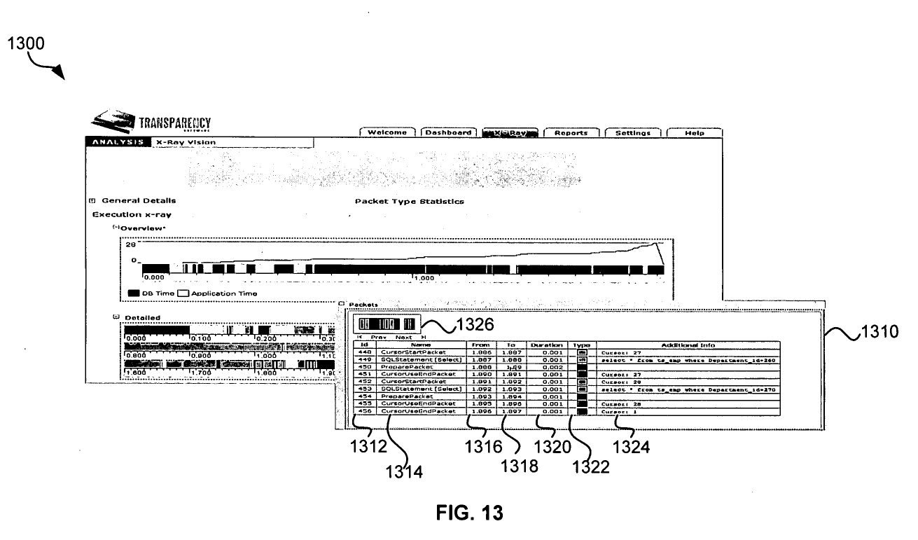

FIGS. 12 and 13 show a screenshot called “X-ray Vision” for a business action. FIG. 12 depicts an X-ray vision screenshot 1200 in an exemplary implementation of the invention. The metrics and graphs depicted in the X-ray screenshot 1200 are for an instance of a business action. The X-ray vision screenshot 1200 includes total execution time 1212, database time 1214, idle time 1216, packet types 1222, packet type counts 1224, packet type color 1226, an overview graph 1230, and a detailed graph 1240.

The total execution time 1212 represents the total time the business action takes to complete. The database time 1214 represents the total time of database operations and a percentage of the total execution time 1212. The idle time 1216 represents the total idle time that the application is not performing database operations and a percentage of the total execution time 1212. These general details can be helpful in determining the overall metrics of the business action to provide statistical information to an administrator.

The packet types 1222 represent all the types of packets in the business action. In this example, the communication messages are communicated using packets. The execution of the business action between the application and the server result in various types of packets being communicated between the application and the server. In other embodiments, the communication messages are received from memory snapshots, which include the communication messages. Some examples of packet types 1222 are CursorEndPacket, CursorStartPacket, SQLStatement, and SessionEndPacket. The packet type counts 1224 represent the total number of each packet types 1222.

The packet type color 1226 represents the assigned color for the packet type. In this example, the packet type color 1226 also includes a “find all” link, which, when selected, displays packet details for all packets in the business action with the selected packet type. The packet type color 1226 graphically assists in recognizing a certain packet type when a graph of packet types for the business action is shown over the execution time of the business action as is described in further details below. These packet type statistics such as packet type 1222, packet count 1224, and packet type color 1226 provide a useful overview of the execution of the business action at the packet type level. Thus, an administrator can easily analyze what types of packets are being communicated in a certain business action.

The overview graph 1230 displays a graph of database time and application time over the execution time of the business action. In this example, each millisecond of the execution time of the business action is colored with the respective color for database time or execution time depending on whether in that millisecond, a database operation was being performed or there was database idle time.

The detailed graph 1240 displays a graph of packet types over the execution time of the business action. In this example, each millisecond of the execution time of the business action is colored with the respective color for the packet type 1222 depending on which packet type 1222 is being transmitted in that millisecond. If the user selects a certain millisecond in the execution time of the business action, a window of packet details for a range of time near the selected millisecond appears as shown in FIG. 13. This ability to drill down the metrics of the business action provides a frame of reference to show a more detailed view of the packets.

FIG. 13 depicts a screenshot 1300 including a packet detail window 1310 in an exemplary implementation of the invention. In this example, the packet detail window 1310 shows the details of nine packets. In other examples, the packet window 1310 can be resized to display any number of packets.

The packet detail window 1310 includes packet identification (ID) 1312, packet name 1314, execution from time 1316, execution to time 1318, a duration 1320, a packet type color 1322, additional info 1324, and a window control 1326.

The packet ID 1312 represents the identification number of the packet. The packet name 1314 represents the name or reference of the packet. The execution from time 1316 represent the beginning time of the business action. The execution to time 1318 represent the ending time of the business action. The duration 1320 represents the duration of time the packet is being processed. The packet type color 1322 represents the respective assigned for the packet type of the packet. The additional information 1324 is any additional information related to the packet. In this example, the additional information 1324 displays the cursor number and the SQL statement associated with this packet.

The window control 1326 displays a range of packet colors that correspond to the range of packets displayed in the packet detail window 1310. The window control 1326 also includes controls for moving the packet detail window 1310 to the next or previous range of packets. This packet detail window 1310 provides the ability to display the details of the packet, which assists an administrator in identifying errors, problems, or bottlenecks.

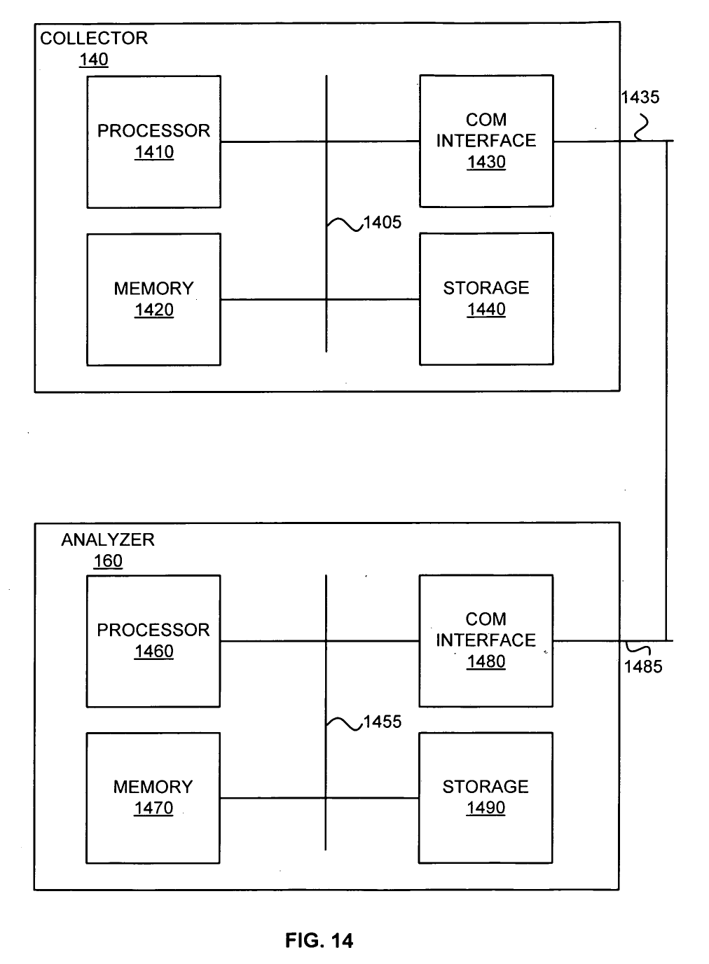

FIG. 14 is a block diagram of the collector 140 and the analyzer 160 in an exemplary implementation of the invention. The collector 140 includes a processor 1410, memory 1420, a communications interface 1430, and storage 1440, which are all coupled to the bus 1405. Bus 1405 provides communications between the processor 1410, the memory 1420, the communications interface 1430, and the storage 1440. The analyzer 160 includes a processor 1460, memory 1470, a communications interface 1480, and storage 1490, which are all coupled to bus 1455. Bus 1455 provides communications between the processor 1460, the memory 1470, the communications interface 1480, and the storage 1490.

The processor 1410 and the processor 1460 execute instructions. The memory 1420 and the memory 1470 permanently or temporarily store data. Some examples of the memory 1420 and the memory 1470 are RAM and ROM. The storage 1440 and the storage 1490 also permanently or temporarily store data. Some example of the storage 1440 and the storage 1490 are hard disks and disk drives.

The communications interface 1430 communicates over a communication network (not shown) with the analyzer 160, the application server 130, and the database server 150 via line 1435 (see FIG. 1). The communications interface 1480 communicates over a communication network (not shown) with the collector 140, the database administrator computer 180, and the database server 170 via line 1485 (see FIG. 1).

FIG. 14 depicts one example of how the collector 140 and the analyzer 160 can be configured. There are numerous variations in which the collector 140 and the analyzer 160 can be configured. In one example, the collector 140 and the analyzer 160 can be combined into one device with a processor and a communication interface. In another example, the collector 140 is the communication interface and the analyzer 160 is the processor.

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

The above-described functions can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for graphically representing an organization action, the method comprising:
receiving communication messages between an application and a server;
processing the communication messages to determine organization actions performed in the application;
determining at least one metric of the organization actions based on the communication messages; and
generating a graphical representation of the metric of the organization actions.

2. The method of claim 1 wherein the communication messages comprise packets.

3. The method of claim 1 wherein the organization actions comprises user interactions with the application.

4. The method of claim 1 wherein the metric comprises time.

5. The method of claim 1 wherein the metric comprises a user identifier.

6. The method of claim 1 wherein the metric comprises an application identifier.

7. The method of claim 1 wherein the visual representation comprises a graph of the metric over time.

8. The method of claim 1 further comprising:
receiving user input for the visual representation; and
generating another visual representation of at least one database event.

9. The method of claim 1 further comprising:
receiving user input for the visual representation; and
generating another visual representation of another metric of the organization actions.

10. The method of claim 1 further comprising searching for the organization actions based on user input.

11. A system for graphically representing an organization action, the system comprising:
a communications interface configured to receive communication messages between an application and a server; and
a processor configured to process the communication messages to determine organization actions performed in the application, determine at least one metric of the organization actions based on the communication messages, and generate a graphical representation of the metric of the organization actions.

12. The system of claim 11 wherein the communication messages comprise packets.

13. The system of claim 11 wherein the organization actions comprises user interactions with the application.

14. The system of claim 11 wherein the metric comprises time.

15. The system of claim 11 wherein the metric comprises a user identifier.

16. The system of claim 11 wherein the metric comprises an application identifier.

17. The system of claim 11 wherein the visual representation comprises a graph of the metric over time.

18. The system of claim 11 wherein the processor is configured to receive user input for the visual representation and generate another visual representation of at least one database event.

19. The system of claim 11 wherein the processor is configured to receive user input for the visual representation and generate another visual representation with another metric of the organization actions.

20. The system of claim 11 wherein the processor is configured to search for the organization actions based on user input.

21. A software product for graphically representing an organization action, the software product comprising:
software operational when executed by a processor to direct the processor to receive communication messages between an application and a server, process the communication messages to determine organization actions performed in the application, determine at least one metric of the organization actions based on the communication messages, and generate a graphical representation of the metric of the organization actions; and
a storage medium configured to store the software.

22. The software product of claim 21 wherein the communication messages comprise packets.

23. The software product of claim 21 wherein the organization actions comprises user interactions with the application.

24. The software product of claim 21 wherein the metric comprises time.

25. The software product of claim 21 wherein the metric comprises a user identifier.

26. The software product of claim 21 wherein the metric comprises an application identifier.

27. The software product of claim 21 wherein the visual representation comprises a graph of the metric over time.

28. The software product of claim 21 wherein the software is operational when executed by the processor to direct the processor to receive user selection for the visual representation and generate another visual representation with another metric of the organization actions.

29. The software product of claim 21 wherein the software is operational when executed by the processor to direct the processor to receive user selection for the visual representation and generate another visual representation of at least one database event.

30. The software product of claim 21 wherein the software is operational when executed by the processor to direct the processor to search for the organization actions based on user input.
